(19) United States
(12) Patent Application Publication
(10) Pub. No.: US 2009/0240584 A1
(43) Pub. Date: Sep. 24, 2009

(54) Method and system for conducting online cash deposit auctions for transacting assets and other goods and services

(76) Inventor: Ajaindra Prakash Singh, Glasgow (GB)

Correspondence Address: Ajaindra Prakash Singh, Flat 11D Grovepark Gardens, North Woodside Road, Glasgow, G20 7JB, GB

(21) Appl. No.: 12/381,755

(22) Filed: Mar. 17, 2009

Related U.S. Application Data
(60) Provisional application No. 61/069,771, filed on Mar. 18, 2008.

(51) Int. Cl. G06Q 30/00

(52) U.S. Cl. 705/14; 705/27

(57) ABSTRACT

The present invention provides a cash deposit auction method and system, whereby upon payment of a fee, a seller uploads details of his business where so desired along with those of the assets, goods and services intended to be sold onto the auction system web-site provided by the manager of auction system. A specified amount of cash from the pool created from the fees paid by the sellers is auctioned. Many buyers make bids for the cash deposit by haggling the price up or down depending on the type of auction they are participating in The cash deposit won in the auction can only be used by the successful bidder to purchase from the seller advertising his business or sale information of any assets, goods and services on the website. The bid-winner is satisfied by buying the items offered for sale with the money won at the auction, the seller gets full value for his assets, goods and services and the auction system manager is compensated by the bid amount and additional service charge, if any paid by the successful bidder.

### CROSS-REFERENCES TO RELATED APPLICATIONS

This patent application is related to and claims priority from U.S. Provisional Patent Application 61/069,771 filed Mar. 18, 2008 entitled METHOD AND SYSTEM FOR CONDUCTING ONLINE CASH DEPOSIT AUCTIONS FOR TRANSACTING ASSETS AND OTHER CONSUMER GOODS AND SERVICES and U.S. Non-Provisional patent application Ser. No. 11/781,303 filed Jul. 23, 2007 entitled METHOD AND SYSTEM FOR BUYING AND SELLING REAL ESTATE AT AN OPTIMAL PRICE ON THE INTERNET which application is incorporated herein by this reference thereto.

### FIELD OF THE INVENTION

The present invention relates generally to a method and system for transacting assets and other consumer goods and services using online cash deposit auctions. More specifically, the present invention involves an internet-based method and software, which allows potential purchasers to buy goods or services they desire after successfully bidding for a specified sum of money on an online auction. In this manner, buyers will be able to subsidize their purchases.

### BACKGROUND OF THE INVENTION

In conventional market items such as real estate assets, luxury cars and other consumer goods and services are often advertised online in order to attract purchasers. However, purchasers can only buy such items provided they can afford to pay for them or if they are able to arrange finances for the purchase. Affordability has always been a major problem. Buyers' desires are unlimited but the means to meet them are limited.

In this context, reverse auction (U.S. Pat. No. 7,024,376) may be useful as it allows purchases to be made at discounted prices. However, reverse bids are usually available only to large businesses or to those who are buying in bulk. In such an approach, buyers state the price at which they are willing to buy and vendors try to match the price. Hence, the vendors have to compete against each other to sell the goods and services at a lowest possible price in order to match the price at which the buyers are willing to buy. Furthermore, the sellers or suppliers are not always able to provide ASSETS OR OTHER goods and services for sale at discounted prices.

Another popular online buying and selling option is the unique lowest bidding, whereby a bidder who has bid for the lowest unique price is the one who is able to obtain the goods and services. There are various sites such as www.unique-bid.com, www.bidclever.com and www.auctionair.com offering buyers the opportunity to bid for goods and services at lowest possible prices. The disadvantage of this method is that the sellers wishing to sell through such websites have to offer discounts to attract potential purchasers. Hence, such approach will not have a wide appeal amongst the sellers as they do not want to accept low prices for their products or services. Furthermore, the bidders will only be able to bid for goods and services, which are offered on the website.

Most importantly, when it comes to selling high-value assets such as real estate assets, the owners are rarely willing to sell their properties at a discount unless there is a pressing need to do so. On the other hand, buyers, especially first time buyers are forced out of the market due to the ever-increasing property prices or lack of mortgages.

What is therefore needed is a method and system which allows the buyers to buy the goods and services they desire at a significant discount or possibly free and the seller to supply those goods and services at their full price without offering any discount. The present invention offers this opportunity.

### SUMMARY OF THE INVENTION

In view of the foregoing disadvantages inherent in the known types of auctions now present in the prior art, the present invention provides a new means by which cash deposit auctions may occur wherein the sellers of goods and services can realize full value while bidders can purchase such items using the cash won in the auction.

The general purpose of the present invention, which will be described subsequently in greater detail, is to provide a cash deposit auction system which is not anticipated, rendered obvious, suggested, taught, or even implied by any of the prior art auctions or auction methods, either alone or in any combination thereof.

In view of the foregoing disadvantages inherent in the known types of auction systems now present in the prior art, the present invention provides a coordinated system by which a person may sell his assets or other consumer goods and services for full value while allowing buyers to purchase these utilizing the fund created from the fees paid by the potential sellers.

The general purpose of the present invention, which is described in greater detail below, is to provide an integrated cash deposit auction sales method by which sellers can market their assets or goods and services to potential buyers at lower costs than using a conventional marketing channel. Assets or other goods and services can then be purchased using the fund that is generated from the fees paid by the potential sellers and which is offered for auction making it easier for buyers to obtain the items without having to pay for their full value.

The system allows the potential sellers to advertise their business details and/or the full details of the assets or other goods and services they want to sell using the system upon a payment of a fee. The fund thus created will then be auctioned off. Depending on the size of the cash to be auctioned off and the duration of the auction period, bidding can be free or pay-per-bid. The auctions can also be either a forward or a reverse auction. In case of the former, the person submitting the highest bid will win the specified amount of cash. In the latter case, the successful bidder will be the one who has the lowest unique bid, which has not been offered by any other bidder.

Once the winner is identified, the successful bidder will proceed with the purchase of the assets or goods and services listed on the web-site or any other goods and services direct from the sellers who advertise their services or businesses on the web-site. Once the successful bidder selects the goods and services, the seller is paid using the cash that was won by the successful bidder in the online cash deposit auction. If the value of the goods and services selected is greater than the cash deposit won, then the winner is asked to pay the difference. Once the winner makes such payment or if there is no difference to be paid, a payment equal to the cash deposit won is made to the relevant sellers on behalf of the winner. Then the bidder takes possession of the property.

As a result, the cash deposit auction process produces opportunity for the buyers to obtain goods and services for free or at a discount and at the same time allowing the sellers to sell those items (whether or not these items are listed on the web-site) at their full price, which otherwise would not have been possible had they chosen a conventional method of buying and selling such goods and services.

### DETAILED DESCRIPTION OF THE INVENTION

The present invention provides a method and system for transacting assets and other consumer goods and services using online cash deposit auctions. The method and system consists of four phases, wherein phase one generates details of assets or goods and services offered for sale through the system or simply the details of the sellers who want to sell any items using the system, phase two alerts and allows potential buyers to bid for the cash deposits, phase three identifies and alerts the successful bidder and phase four allows the winner to select any items whether or not listed on the website from those sellers who advertise their businesses on the site and allows the successful bidder to pay for the item using the auctioned cash.

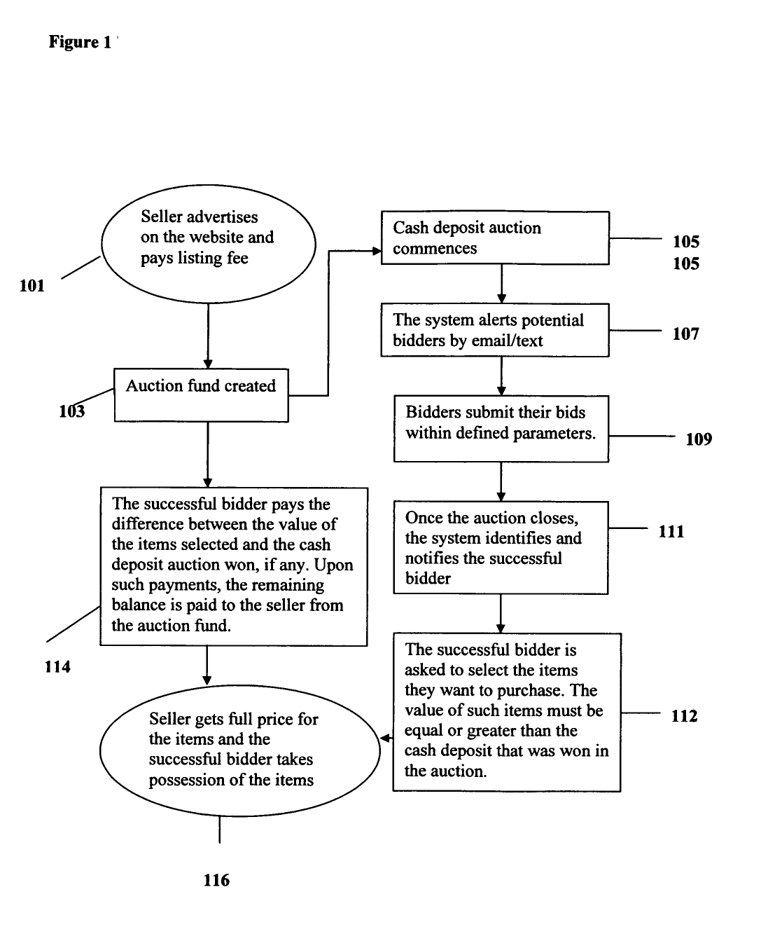

In the following details description, like reference numerals are used to refer to various elements of the invention shown in the figure thereof. Referring now to FIG. 1, the advertising, auctioning and auction funding of the invention comprising a four-phase process is shown.

Phase one: In phase one (101), the system allows the potential seller to upload their own logo, business descriptions or the description of the assets or goods and services they want to sell through the system. The sellers then pay for the listing in a specified manner. The listing fee is then utilised to create a fund to run daily, weekly or monthly auctions (103). Depending on the size of the available fund, the administrator sets the auction closing date and invites potential purchasers to bid for the cash deposits offered for auction (105).

The seller utilizes an input device such as a PC to access the advertising and auctioning website associated with the cash deposit auction method (101). The cash deposit auction website includes a server and any combination of hardware and software necessary to carry out the functions described herein.

Phase two: Once the details have been posted, the system then alerts the potential bidders whose details exist in the system's database, about the assets or goods and services, sellers' businesses and the cash auctions by sending to their computers and/or text messages to their mobile phones (107). The purchasers can then view one or more web pages associated with the advertising-auctioning process. From one of the web pages, the purchasers provide payment details and enter their bid (109). The server associated with the advertising-auctioning site receives the data pertaining to the bid. The bidders can regularly monitor their bid position by logging on to their account on the website.

Phase three: Once the auction closes, the system identifies the winning bid and the successful bidder is informed by email/text messages (111). The successful bidder is then given instruction to select any of the assets, consumer goods and services they want to purchase listed on the website or other unlisted items from the sellers whose detail appear on the site (112).

Phase four: Once the successful bidder confirms that the assets or goods and services equal to or greater than the value of the cash deposit auction have been selected, the winner will be able to purchase the items selected using the cash deposit won at the auction. In cases where the value of the item chosen is greater than the cash deposit won, the successful bidder will be asked to pay any difference between the total value of the items thus selected and the cash deposit won in the auction (114). Once such payment is made to the seller or if the value of the goods and services selected is equal to the cash deposit won, the cash deposit is released to the seller after which the purchaser can collect the goods and services to close the deal (116).

The present invention has the following benefits listed below:

1. The present invention is an innovative cash deposit auction system based on bidders competing to win the cash deposit at the lowest or highest possible cost at the end of the auction but which still satisfies not only the bid-winner, but the seller and auction system manager as well.

2. This system allows for the buyers to secure additional purchasing power by bidding for the cash auction which if won can be used to buy the goods and services from the seller who has advertised on the website.

3. Using this system sellers can not only advertise their businesses and assets goods or services for sale on the website but also utilize alternative mechanism for funding the purchases of their customers who want to buy these assets, goods or services from them.

1. A method for advertising businesses or goods and services and conducting cash auction via a communications network such as an Internet website comprising the steps of;
(a) a seller accessing the cash deposit auction website;
(b) the seller uploading business information or information of goods and services for sale to the website;
(c) collecting a fee for advertisement and information uploaded to the website
(d) creating and maintaining a common pool of money funded by the fees collected from sellers;
(e) making said listing information available to prospective bidders;
(f) allowing prospective bidders to register to bid on cash deposit;
(g) registered bidders place bids on the website;
(i) (Canceled)
(j) determining which bidder has placed the winning bid;
(k) awarding and allowing the winning bidder to use the cash deposit thus auctioned to purchase assets, goods and/or services from the sellers advertising their businesses and items for sale on the website.

2. A method for conducting a cash deposit auction via a communications network such as an Internet website as set forth in claim 1, further comprising:
collecting a fee for said seller uploading specific business advertisement or assets, goods and services sales information regarding an item or items for sale to the website.

3. A method for conducting a cash deposit auction via a communications network such as an Internet website as set forth in claim 1, further comprising:
said business advertisement or specific assets, goods and services sales information includes business logos and description and photographs, specification and actual value of the assets, goods and services.

4. A method for conducting a cash deposit auction via a communications network such as an Internet website as set forth in claim 4, further comprising:
selection and notification of the successful bidder at the end of the auction period.

5. A method for conducting a cash deposit auction via a communications network such as an Internet website as set forth in claim 1, further comprising:
said making the listing information available to prospective bidders facilitated via email, text message or other electronic means of communication.

6. A method for conducting a cash deposit auction via a communications network such as an Internet website as set forth in claim 1, further comprising:
collecting the winning bid amount from winning bidder.

7. A method for conducting a cash deposit auction via a communications network such as an Internet website as set forth in claim 7, further comprising:
successful bidder using the cash deposit won in the auction to pay the seller the total value of assets, goods or services.

8. A method for conducting a cash deposit auction via a communications network such as an Internet website as set forth in claim 8, further comprising:
said winning bidder paying an additional fee for services rendered by said website owner.

9. A system for conducting a cash deposit auction via a communications network such as an Internet website comprising;
(a) a computer server;
(b) a website administrator;
(c) a cash deposit auction website hosted on said computer server and maintained by said website administrator;
(d) a software program customized to facilitate operation of said website;
(e) a secure database used to collect and hold information;
(f) sellers who access the cash deposit auction website via an input device means;
(g) means for uploading business descriptions and specific assets, goods and services sales information to the website by the seller onto said database;
(h) means for collecting fees for each information or advertisement uploaded by seller;
(i) means for creating and maintaining a common pool of money funded by the fees collected from sellers;
(j) a plurality of prospective bidders register their details into said database using an input device means to bid on cash deposits;
(k) means for making said goods and services sales information available to prospective bidders;
(l) a plurality of registered bidders to place bids on the website by using said input device means to send bid information to said server; and
(o) means for awarding the cash to the successful bidder allowing the bidder to use the cash to purchase assets, goods and items from the sellers advertising on the website.

10. A system for conducting a cash deposit auction via a communications network such as an Internet website comprising as set forth in claim 10 further comprising;
said input device means used by sellers and bidders to access said website is a PC.

11. A system for conducting a cash deposit auction via a communications network such as an Internet website comprising as set forth in claim 10 further comprising;
said means for making said assets, goods and services sales information available to prospective bidders includes the use of email and text messaging.

12. A method for conducting a cash deposit auction via a communications network such as an Internet website comprising the steps of;
(a) a seller accessing the cash deposit auction website;
(b) uploading business information along with specific assets, goods and services sales information regarding an item for sale to the website by the seller;
(c) creating and maintaining a common pool of money funded by the fees collected from sellers;
(d) allowing prospective bidders to register to bid on cash being auctioned;
(e) making said listing information available to prospective bidders;
(f) registered bidders place bids on the website;
(g) determining which bidder has placed the winning bid;
(h) collecting the winning bid amount from winning bidder;
(i) awarding the cash thus won in the cash deposit auction to the successful bidder
(j) allowing the successful bidder to use the cash won in the auction to pay the seller the total value of the goods or services purchased; and
(k) allowing the bidder to collect the items sold by the sellers.
